(19) United States
(12) Patent Application Publication
(10) Pub. No.: US 2004/0100657 A1
(43) Pub. Date: May 27, 2004

(54) Method and apparatus for utilizing memory of printer

(75) Inventor: Sung-hi Lee, Gyeonggi-do (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon-city (KR)

(21) Appl. No.: 10/644,096

(22) Filed: Aug. 20, 2003

(30) Foreign Application Priority Data
Sep. 23, 2002 (KR) 2002-57645

(51) Int. Cl. G06F 15/00

(52) U.S. Cl. 358/1.16; 358/1.13

(57) ABSTRACT

Utilizing a memory of a printer by storing emulation information selected from among a plurality of emulation information stored into a first memory into a predetermined storage area in a second memory and analyzing a type of emulation information of received printing data to determine whether a type of the emulation information stored into the predetermined storage area matches the type of the emulation information analyzed. If the type of the emulation information stored into the predetermined storage area does not match the type of the emulation information analyzed, emulation information of a type matching the type of the emulation information analyzed is retrieved from the first memory and stored into the predetermined storage area. Active emulation information is stored in a predetermined storage area of a second memory, such as a RAM, allowing diversely formatted information to be printed using the active emulation information without increasing memory capacity.

### CROSS-REFERENCE TO RELATED APPLICATIONS

This application claims the priority benefit of Korean Patent Application No. 2002-57645, filed Sep. 23, 2002, in the Korean Intellectual Property Office, the disclosure of which is incorporated herein by reference in their entirety.

### BACKGROUND OF THE INVENTION

1. Field of the Invention

The present invention relates to a method and apparatus for practically using a memory of a printer that supports various emulation modes, and more particularly, to a method and apparatus for utilizing a memory of a printer designed to store necessary emulation data into a specific storage location.

2. Description of the Related Art

In general, all types of printers support different emulation modes. Data is output as unrecognizable characters if a mode in which data is sent from a host to a printer is different from a mode in which the printer receives the data. To prevent the above problem, emulation information is used to support specified standard formats, such as font size, graphics, compression of a printing data, and colors. Conventional printers that support various emulation modes retain emulation data as a component of a firmware, which is a program required for printing. Such conventional printers store uncompressed emulation data in a memory, retrieve the stored emulation data that supports printing, and execute the printing operations. More particularly, such conventional printers store all emulation data in compressed form in a Flash Read Only Memory (ROM), uncompress the emulation data into a Random Access Memory (RAM) when being initialized and put into a different mode, and use the uncompressed emulation data required for printing to resume a printing operation.

As functions and emulation modes supported by printers increasingly become more complicated and diversified, the size of a firmware program managing the emulation data increases, so that the memory area in a Flash ROM to store the emulation data also increases. To solve these problems, a method to store emulation data in a compressed form into a ROM has been typically used. However, in printers supporting various emulation modes, using emulation data after uncompressing all compressed emulation data stored in the Flash ROM during printer initialization causes an inefficient use of the RAM space due to storage of unnecessary emulation data, because only one type of emulation data required for printing is selected to execute printing. To solve this problem, a method to store only specific emulation data in a RAM rather than store all emulation data has been adopted. U.S. Pat. No. 6,128,094 discloses a method in which a printer memory stores the emulation data required for printing. However, in a case where another emulation data is required with the specific emulation data stored in the RAM as described above, the newly required data is stored in a new location of the RAM instead of the old location where the existing emulation data has been stored. This also leads to an inefficient use of the RAM space, because additional space is required for the new emulation data.

### SUMMARY OF THE INVENTION

The present invention provides a method of utilizing a memory of a printer designed to provide a separate area of a second memory, such as a Random Access Memory (RAM), dedicated to storing emulation data. The present invention also provides an apparatus utilizing a memory of a printer by providing a separate memory area dedicated to storing emulation data.

Additional aspects and advantages of the invention will be set forth in part in the description which follows and, in part, will be obvious from the description, or may be learned by practice of the invention.

The present invention may be achieved by a method of utilizing a printer memory comprising storing emulation information selected from among a plurality of emulation information stored into a first memory in a predetermined storage area of a second memory when a printer is initialized; analyzing a type of emulation information to support printing of a printing data transmitted to the printer; determining whether a type of the emulation information stored into the predetermined storage area in the second memory matches the type of the emulation information analyzed; and, if the type of the emulation information stored at the predetermined storage area does not match the type of the emulation information analyzed, retrieving emulation information from the first memory that matches the analyzed type of emulation information and storing the retrieved emulation information into the predetermined storage area of the second memory.

The present invention may be also achieved by a printer memory utilization apparatus comprising an emulation information retrieving unit that retrieves emulation information from among a plurality of emulation information stored into a first memory and stores the retrieved emulation information into a predetermined storage area of a second memory; a printing data analyzing unit that analyzes a type of emulation information to support printing of a printing data and outputs the type of the emulation information analyzed; and emulation information comparing unit that compares a type of the emulation information stored into the predetermined storage area in the second memory with the type of the emulation information analyzed and outputs the result of comparison to the emulation information retrieving unit to retrieve emulation information from the first memory matching the analyzed type of emulation information.

### BRIEF DESCRIPTION OF THE DRAWINGS

The above and/or other aspects and advantages of the present invention will become more apparent and more readily appreciated from the following description of the embodiments, taken in conjunction with the accompanying drawings of which:

FIG. 1 is a flowchart of utilizing a memory of a printer, according to an embodiment of the present invention; and

FIG. 2 is a block diagram of an apparatus utilizing a memory of a printer, according to an embodiment of the present invention.

### DETAILED DESCRIPTION OF THE PREFERRED EMBODIMENTS

Reference will now be made in detail to the present embodiments of the present invention, examples of which are illustrated in the accompanying drawings, wherein like reference numerals refer to the like elements throughout. The embodiments are described below to explain the present invention by referring to the figures.

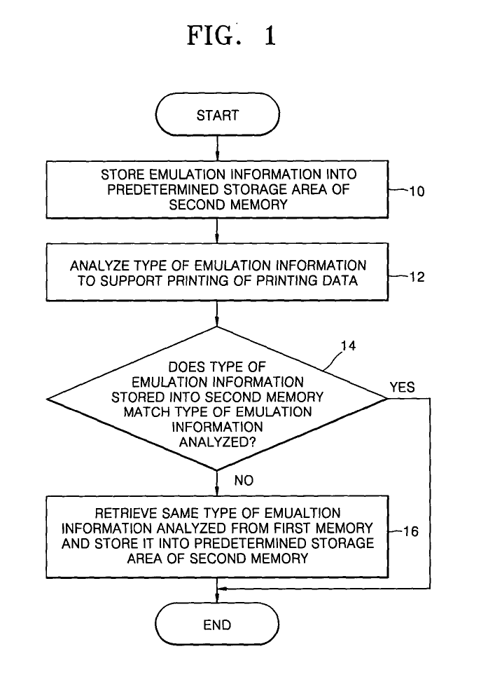

Referring to FIG. 1, a method of utilizing a memory of a printer comprises operations 10 through 16 of determining whether a type of existing (active) emulation information stored into a predetermined storage area of a second memory matches a type of the emulation information required for printing and storing a new emulation information in a location where the existing emulation information has been stored.

More particularly, at operation 10, printer emulation information selected from among a plurality of emulation information stored into a first memory, as inactive printer emulation information, is stored in a predetermined storage area in a second memory, as active printer emulation information, when the printer is initialized. The emulation information stored in the first memory may be available in uncompressed or compressed form. Typically, the first memory is a Read Only Memory (ROM) and the second memory is a Random Access Memory (RAM). When power is applied to the printer, a boot image program, which is a component of a firmware program, initializes the printer. During this initialization or boot process, the emulation information selected from the emulation information stored in the ROM (i.e., the first memory) is stored at a predetermined storage area of the RAM (i.e., a second storage area as an active printer emulation information storage). If the emulation information has been compressed, the relevant formation is uncompressed and then stored into the RAM.

The predetermined storage area of the second memory is a commonly designated storage area storing any type of a plurality of printer emulation information therein as active printer emulation information. The predetermined storage area in the second memory has a storage capacity corresponding to emulation information having the biggest size from among all the emulation information. Therefore, typically, the storage capacity of the predetermined storage area in the second memory allows storing the largest size uncompressed emulation information.

At operation 12, the type of emulation information to support printing of printing data transmitted to the printer is analyzed. Once the printing data has been input to the printer, header information of the printing data is analyzed to determine a type of emulation information supporting the input printing data from among the plurality of emulation information types. At operation 14, it is determined whether the type of emulation information stored into the predetermined storage area of the second memory matches the type of the emulation information analyzed (i.e., whether the active emulation information type matches emulation information type of the input print data). If, at operation 14, it is determined that the two types match each other, a printing operation is executed.

However, if operation 14 determines that the type of the emulation information stored into the predetermined storage area (i.e., the active printer emulation information) does not match the type of the emulation information analyzed, in operation 16, the same type of emulation information as the emulation information type of the input printing data is retrieved from the first memory and stored in the predetermined storage area of the second memory, as a new active printer emulation information. Typically, the previously active emulation information stored in the predetermined storage area of the second memory is deleted (i.e., the previously active emulation information is replaced with a new active emulation information). Therefore, if at operation 14, the type of the emulation information previously stored into the second memory is not the same type of the emulation information for printing the received printing data, at operation 16, the emulation information for printing the received printing data is retrieved from among the plurality of emulation information stored in the first memory. The retrieved emulation information is stored at the predetermined storage area of the second memory, as the new active emulation information, where the previous emulation information has been stored.

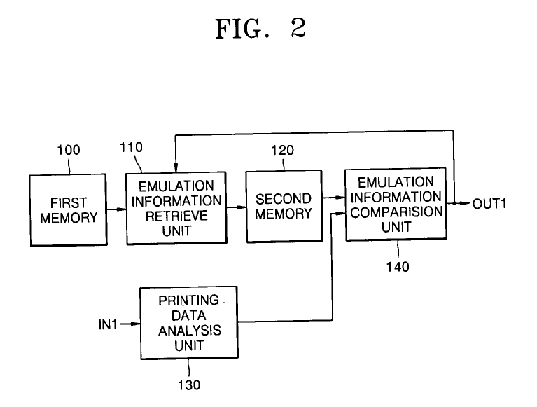

The configuration and operation of an apparatus utilizing a memory of a printer according to an embodiment of the present invention will now be described with reference to FIG. 2. FIG. 2 is a block diagram of the apparatus utilizing a memory of a printer, comprising a first memory 100, an emulation information retrieving unit 110, a second memory 120, a printing data analyzing unit 130, and an emulation information comparing unit 140. Typically, the first memory 100 stores a plurality of printer emulation information in a compressed or uncompressed form. The first memory 100 is typically a ROM.

During printer initialization, the emulation information retrieving unit 110 retrieves arbitrary or predetermined printer emulation information from among the plurality of emulation information stored in the first memory 100 and stores the retrieved emulation information into a predetermined storage area of the second memory 120 as the active printer emulation information. For example, typically, the emulation information is retrieved from among the relatively frequently used emulation information. The emulation information retrieving unit 110 also receives a comparison result from the emulation information comparing unit 140, and retrieves another type of the emulation information based on the comparison result from the first memory 100, and stores the newly retrieved emulation information in the predetermined storage area of the second memory 120, as a newly activated printer emulation information.

The second memory 120 has a predetermined storage area designed to store any arbitrary emulation information, thereby providing an active printer emulation information storage. Typically, the predetermined storage area of the second memory 120 is a commonly designated RAM storage area storing any type of a plurality of emulation information therein. Newly retrieved emulation information (activated printer emulation information) is stored into the same area of the predetermined storage area where the previous emulation information has been stored. The predetermined storage area in the second memory has a storage capacity corresponding to emulation information having the biggest size from among the plurality of emulation information stored in the first memory 100. Typically, the storage capacity of the predetermined storage area in the second memory allows storing biggest size uncompressed emulation information.

The printing data analyzing unit 130 analyzes a type of emulation information to support printing of printing data received by the printer through an input terminal IN1 and outputs the type of emulation information analyzed. Typically, the printing data analyzing unit 130 analyzes header information of the received printing data to identify the type of the emulation information and outputs the result of the analysis to the emulation information comparing unit 140.

The emulation information comparing unit 140 compares a type of the emulation information stored into the predetermined storage area of the second memory 120, as the active printer emulation information, with the type of the emulation information analyzed by the printing data analysis unit 130, and outputs the comparison result through an output terminal OUT1 to the emulation information retrieving unit 110. If the two emulation information types match each other as a result of the comparison, printing is executed. Conversely, if the two emulation information types do not match according to the comparing, the emulation information retriever 110 retrieves another emulation information required to perform printing of the printing data from the first memory 100 and stores the newly retrieved matching emulation information in the second memory 120. Accordingly, the processes of the present invention as embodied in the emulation information retriever 110, the emulation information comparator 140 and the received printing data analysis unit 130, activate and deactivate printer emulation information according to received printing data type. The processes of the present invention can be implemented in software and/or computing hardware.

As described above, a print memory utilization method and apparatus according to the present invention stores printer emulation information into a common storage area of a second memory, such as a RAM, as active printer emulation information, thus allowing diverse information to be printed using emulation information without increasing the storage capacity of the second memory. More particularly, the present invention provides a printer controller utilizing a memory of a printer according to a process of storing emulation information selected from among a plurality of emulation information stored into a first memory into a predetermined storage area in a second memory, when the printer is initialized, and analyzing a type of emulation information of received printing data to determine whether a type of the emulation information stored into the predetermined storage area matches the type of the emulation information analyzed. If the type of the emulation information stored into the predetermined storage area does not match the type of the emulation information analyzed, the controller retrieves from the first memory emulation information type matching the type of the emulation information analyzed and stores the retrieved matching emulation information into the predetermined storage area (i.e., the controller replaces the previously active emulation information with a new active emulation information). Accordingly, emulation information stored in a non-volatile memory, such as a ROM, is activated by being stored in a predetermined storage area of a printer volatile memory, such as a RAM, accessible by the printer applications, allowing diversely formatted information to be printed using the active emulation information without increasing the volatile memory capacity. Therefore, the present invention activates and deactivates printer emulation information (modes) in a predetermined RAM area in response to emulation information type of received print data.

While this invention has been particularly shown and described with reference to a few embodiments thereof, it will be understood by those skilled in the art that various changes in form and details may be made therein without departing from the spirit and scope of the invention as defined by the appended claims and their equivalents.

What is claimed is:

1. A method of utilizing a memory of a printer printing using emulation information stored in a first or a second memory, the method comprising:
storing emulation information selected from among a plurality of emulation information stored into the first memory into a predetermined storage area of the second memory when the printer is initialized;
analyzing a type of emulation information of printing data transmitted to the printer;
determining whether a type of the emulation information stored into the predetermined storage area of the second memory matches the type of the emulation information analyzed; and
if the type of the emulation information stored into the predetermined storage area does not match the type of the emulation information analyzed, retrieving an emulation information type from the first memory matching the type of the emulation information analyzed and storing the retrieved emulation information into the predetermined storage area of the second memory.

2. The method of claim 1, wherein the predetermined storage area of the second memory has a storage capacity to store a biggest size emulation information from among the plurality of emulation information stored in the first memory.

3. A printer memory utilization apparatus printing using emulation information stored in a first or a second memory, the apparatus comprising:
an emulation information retrieving unit that retrieves emulation information from among a plurality of emulation information stored into the first memory and stores the retrieved emulation information into a predetermined storage area of the second memory;
a printing data analyzing unit that analyzes a type of emulation information of received printing data to support printing the received printing data and outputs the type of the emulation information analyzed; and
an emulation information comparing unit that compares a type of the emulation information stored into the predetermined storage area of the second memory with the type of the emulation information analyzed and outputs a comparison result,
wherein the emulation information retrieving unit retrieves an emulation information type from the first memory matching the type of the emulation information analyzed, in response to the comparison result, and stores the retrieved emulation information into the predetermined storage area of the second memory.

4. The apparatus of claim 3, wherein the predetermined storage area of the second memory has a storage capacity to store a biggest size emulation information from among the plurality of the emulation information stored in the first memory.

5. The apparatus of claim 3, wherein the first memory is a read only memory (ROM) and the second memory is a random access memory (RAM).

6. The apparatus of claim 3, wherein the emulation information retrieving unit retrieves the matching emulation information type from the first memory, if according to the comparison result the emulation information type of the received printing data does not match the emulation information type stored in the predetermined storage area of the second memory.

7. A printer, comprising:
a first memory storing a plurality of deactivated printer emulation information;
a second memory storing active emulation information; and
a programmed computer processor performing a process, comprising:
analyzing a type of emulation information of received print data,
determining whether a type of the active emulation information matches the analyzed emulation information type of the received print data, and
storing in the second memory, from the deactivated emulation information stored in the first memory, an emulation information type matching the analyzed emulation information type of the received print data according to the determining, as a new activated emulation information.

8. The printer of claim 7, wherein the first memory is a non-volatile memory and the second memory is a volatile memory.

9. The printer of claim 7, wherein the plurality of deactivated emulation information stored in the first memory are in compressed or uncompressed form, and
the programmed computer processor retrieves compressed deactivated emulation information from the first memory, decompresses the retrieved deactivated emulation information, and stores the retrieved decompressed deactivated emulation information in the second memory as the new activated emulation information.

10. A printer, comprising:
a programmed computer processor activating and deactivating printer emulation modes in a predetermined random access memory area in response to emulation information type of received print data.

11. The apparatus of claim 3, wherein the plurality of emulation information stored in the first memory are in compressed or uncompressed form and the emulation information retrieving unit decompresses compressed emulation information retrieved from the first memory and stores the retrieved decompressed emulation information in the predetermined storage area of the second memory.
